(19) United States
(12) Patent Application Publication
(10) Pub. No.: US 2026/0155763 A1
(43) Pub. Date: Jun. 4, 2026

(54) POWER GENERATION DEVICE BASED ON DOUBLE-SIDED ROTARY FRICTION

(71) Applicant: ENERGY MINING Co., Ltd., Suwon-si, Gyeonggi-do (KR)

(72) Inventors: Hyunmoon PARK, Gunpo-si (KR); Changheon LEE, Suwon-si (KR); Jangmook JEONG, Suwon-si (KR)

(73) Assignee: ENERGY MINING Co., Ltd., Suwon-si, Gyeonggi-do (KR)

(21) Appl. No.: 18/963,846

(22) Filed: Nov. 29, 2024

(30) Foreign Application Priority Data
Mar. 20, 2024 (KR) 10-2024-0038339

(51) Int. Cl. H02N 1/04

(52) U.S. Cl. CPC H02N 1/04

(57) ABSTRACT

A power generation device includes: a first housing having a first hole, a rotating shaft being configured to be rotated by external force and extending in a first direction; a rotating portion having a second hole, and including a first negative charge inducing layer and a second negative charge inducing layer each arranged along the first direction, and a first electric insulation layer between the first negative charge inducing layer and the second negative charge inducing layer; and a fixed portion having a third hole through which the rotating shaft penetrates, and including a first positive charge inducing layer and a second positive charge inducing layer each arranged along the first direction, and a second electric insulation layer between the first positive charge inducing layer and the second positive charge inducing layer.

### CROSS-REFERENCE TO RELATED APPLICATION

The present application is based upon and claims the benefit of priority to Korean Patent Application No. 10-2024-0038339 filed on Mar. 20, 2024. The disclosures of the above-listed application are hereby incorporated by reference herein in their entirety.

### BACKGROUND OF THE INVENTION

### Field of the Invention

Embodiments of the present disclosure relate to a power generation device, and more particularly, to a power generation device based on double-sided rotary friction, the power generation device configured such that a physical phenomenon in positive and negative charges move to a particular potential is resolved.

### Background of the Related Art

A friction power generation device using rotational motion generates alternating current (AC) or direct current (DC) electricity through charged materials of a rotating portion and a fixed portion. Electricity produced in the charged materials is transferred via two electrodes in which a potential difference occurs. The friction power generation device using the rotational motion may move various physical energies, such as vertical or horizontal energy, in a particular direction to provide power generation energy through rotational force. In other words, the friction power generation device may be utilized as an energy source to supply power to various devices. A system using the friction power generation device using the rotational motion may have advantages as described below.

First, the system may be applied to various devices from a small size of a self-generation medical device or an Internet of things (IoT) device to a large size of a wind power generator or a hydroelectric generator. The system only needs a power converter to transmit power, thus allowing for a simple structure.

Second, the system may convert various external energy such as kinetic energy delivered through gears or mechanical portions to provide power generation energy. The system has characteristic of ‘miniaturization’ capable of being used in a certain installation space regardless of a place or environment without a need for a separate power generation source. Particularly, an energy conversion and storage environment including a multi-faceted power generation device according to friction based on rotation may generate high energy with low energy compared to frictional electricity in a form of vertical or horizontal friction based on a single area. Additionally, efficiency of friction power generation according to transmission force is significantly higher than that of other methods.

### SUMMARY OF THE INVENTION

However, in a power generation device in the related art, when electrodes are disposed on both sides of a frictional electric device or material using a frictional rotation method, revolutions per minute (RPM) are increased. Thus, when an amount of power generation increases, such a problem that a potential is increased only on one side due to a particular potential difference occurs.

Therefore, the present disclosure has been made in view of the above problems, and it is an object of the present disclosure to provide a power generation device based on double-sided rotary friction, the power generation device configured such that a physical phenomenon in positive and negative charges move to a particular potential is resolved. However, one or more embodiments are only examples, and the scope of the present disclosure is not limited thereto.

To accomplish the above object, according to one aspect of the present disclosure, there is provided a power generation device including: a first housing having a first hole through which a rotating shaft penetrates, the rotating shaft being configured to be rotated by external force and extending in a first direction; a rotating portion having a second hole through which the rotating shaft penetrates to be thereby rotated by the rotating shaft, and including a first negative charge inducing layer and a second negative charge inducing layer each arranged along the first direction, and a first electric insulation layer between the first negative charge inducing layer and the second negative charge inducing layer; and a fixed portion having a third hole through which the rotating shaft penetrates, and including a first positive charge inducing layer and a second positive charge inducing layer each arranged along the first direction, and a second electric insulation layer between the first positive charge inducing layer and the second positive charge inducing layer, wherein, according to rotation of the rotating shaft and the rotating portion, electric energy is generated by triboelectrification between at least one of the first negative charge inducing layer and the second negative charge inducing layer and at least one of the first positive charge inducing layer and the second positive charge inducing layer.

According to the present embodiment, the rotating portion and the fixed portion may be provided in plurality, respectively, and the plurality of rotating portions and the plurality of fixed portions may be alternately arranged along the first direction.

According to the present embodiment, the second electric insulation layer of the fixed portion may have a thickness of about 400 μm to about 1600 μm.

According to the present embodiment, the second electric insulation layer of the fixed portion may have at least one air gap therein.

According to the present embodiment, the second electric insulation layer of the fixed portion may include a second-first electric insulation layer and a second-second electric insulation layer sequentially arranged along the first direction, and the second-first electric insulation layer and the second-second insulation layer may have different internal material arrangements from each other.

According to the present embodiment, the second electric insulation layer of the fixed portion may include a second-first electric insulation layer, a second-second electric insulation layer, and a second-third electric insulation layer disposed between the second-first electric insulation layer and the second-second electric insulation layer, and the second-third electric insulation layer may include an insulating material different from an insulation material of each of the second-first electric insulation layer and the second-second electric insulation layer.

According to the present embodiment, each of the first positive charge inducing layer and the second positive charge inducing layer of the fixed portion may include a plurality of electrode layers having widths different from each other and arranged in parallel along the first direction.

According to the present embodiment, the widths of the plurality of electrode layers may gradually decrease in a direction away from the second electric insulation layer of the fixed portion.

According to the present embodiment, the plurality of electrode layers may have one side edge respectively, the respective side edges overlapping one another in the first direction.

According to the present embodiment, wherein the first negative charge inducing layer and the second negative charge inducing layer of the rotating portion may be symmetrical to each other with respect to the first electric insulation layer of the rotating portion, and the first positive charge inducing layer and the second positive charge inducing layer of the fixed portion may be symmetrical to each other with respect to the second electric insulation layer of the fixed portion.

According to the present embodiment, the second hole may have a size substantially identical to a size of a penetration surface of the rotating shaft, and the third hole may have a size larger than the size of the second hole.

According to the present embodiment, each of the rotating portion and the fixed portion may have a disc shape, and the second electric insulation layer of the fixed portion may include a protruding portion extending from the disc shape in a second direction crossing the first direction.

According to the present embodiment, the protruding portion may include a first protruding portion and a second protruding portion directing opposite to each other along the second direction, and the fixing portion may further include: a first output portion disposed on an upper surface of the first protruding portion and electrically connected to the first positive charge inducing layer; and a second output portion disposed on a lower surface of the second protruding portion and electrically connected to the second positive charge inducing layer.

According to the present embodiment, the power generation device may further include a bearing disposed within the first hole and surrounding the rotating shaft.

According to the present embodiment, the power generation device may further include a handle which extends in a second direction perpendicular to the first direction to be connected to the rotating shaft, and to which the external force is input.

According to the present embodiment, the power generation device may further include a second housing arranged to face the first housing and fixed to the first housing, and the rotating portion and the fixed portion may be arranged within the second housing.

In addition to those described above, other aspects, features and effects will become apparent from the following drawings, claims, and detailed descriptions of the present disclosure.

These general and specific embodiments may be implemented by using a system, a method, a computer program, or a combination of the system, the method, and the computer program.

As described above, according to one embodiment of the present disclosure, a power generation device based on double-sided rotary friction, the power generation device configured such that a physical phenomenon in positive and negative charges move to a particular potential is resolved, may be implemented. However, the scope of the present disclosure is not limited by the effects described above.

### BRIEF DESCRIPTION OF THE DRAWINGS

FIG. 1 is an exploded perspective view schematically illustrating a power generation device according to an exemplary embodiment of the present disclosure.

FIG. 2 is an exploded perspective view schematically illustrating an internal structure of the power generation device according to an exemplary embodiment of the present disclosure.

FIG. 3 is an exploded perspective view schematically illustrating a rotating portion and a fixed portion according to an exemplary embodiment of the present disclosure.

FIG. 4 is a perspective view schematically illustrating a structure in which the power generation device of FIG. 2 is partially assembled.

FIG. 5 is a schematic diagram of a rotating portion and a fixed portion according to an exemplary embodiment of the present disclosure.

FIG. 6 is a cross-sectional view schematically illustrating a rotating portion and a fixed portion according to an exemplary embodiment of the present disclosure.

FIG. 7 is a cross-sectional view schematically illustrating a rotating portion and a fixed portion according to an exemplary embodiment of the present disclosure.

FIG. 8 is a cross-sectional view schematically illustrating a rotating portion and a fixed portion according to an exemplary embodiment of the present disclosure.

FIG. 9 illustrates graphs showing a power generation amount in a comparative example and a power generation amount according to the embodiment of FIG. 7.

FIG. 10 illustrates cross-sectional views showing a difference between total heights of elements according to single-sided power generation and double-sided power generation in a rotating portion and a fixed portion.

FIG. 11 show tables specifically presenting thicknesses (heights) of the rotating portion and the fixed portion of FIG. 10B and FIG. 10C.

FIG. 12 is an exemplary diagram for explaining synchronization of a power generation device according to an exemplary embodiment of the present disclosure.

FIG. 13 is a graph showing a comparison of an impedance (Z) and power of a device according to synchronization and unsynchronization of a power generation device.

FIG. 14 is a diagram for explaining a fixing portion according to an exemplary embodiment of the present disclosure.

FIG. 15 is a diagram for explaining a fixing portion according to an exemplary embodiment of the present disclosure.

FIGS. 16 and 17 are diagrams for explaining an example of utilizing the power generation device according to an exemplary embodiment of the present disclosure.

### DETAILED DESCRIPTION OF THE PREFERRED EMBODIMENT

Since the present disclosure may have various modifications and several embodiments, embodiments are shown in the drawings and will be provided in the detailed description in detail. Effects and features of the present disclosure and methods of accomplishing the same may be understood more readily with reference to the following detailed description of embodiments and the accompanying drawings. However, the present disclosure is not limited to the embodiments set forth herein, and may be embodied in many different forms.

It will be understood that although the terms “first,” “second,” etc. may be used herein to describe various components, these components should not be limited by these terms. These components are only used to distinguish one component from another.

As used herein, the singular forms “a,” “an” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

It will be understood that when a layer, region, or component is referred to as being “arranged on,” another layer, region, or component, it can be directly or indirectly arranged on the other layer, region, or component. That is, for example, intervening layers, regions, or components may be present.

Sizes of elements in the drawings may be exaggerated for convenience of explanation. In other words, since sizes and thicknesses of components in the drawings are arbitrarily illustrated for convenience of explanation, the following embodiments are not limited thereto.

When a certain embodiment may be implemented differently, a particular process order may be performed differently from the described order. For example, two consecutively described processes may be performed substantially at the same time or performed in an order opposite to the described order.

In the present specification, “A and/or B” refers to A or B, or A and B. In addition, “at least one of A and B” refers to A or B, or A and B.

It will be understood that when a layer, region, or component is referred to as being connected to or coupled to another layer, region, or component, it may be directly connected or coupled to the other layer, region, or component, and/or indirectly connected to the other layer, region, or component with intervening elements therebetween. For example, when a layer, region, or component is referred to as being electrically connected to or coupled to another layer, region, or component, it may be electrically directly connected or coupled to the other layer, region, or component, and/or electrically indirectly connected to the other layer, region, or component with intervening elements therebetween.

The x-axis, the y-axis and the z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

As used herein, the term is intended to illustrate the embodiments but is not intended to limit the inventive concept. In this specification, the singular includes the plural unless specifically stated otherwise. It will be further understood that the terms “comprises,” “comprising,” “includes,” and/or “including,” when used herein, specify the presence of members, but do not preclude the presence or addition of one or more other members, unless otherwise specified.

A word “exemplary” used herein means “used as an example or illustration.” Any embodiment described herein as “exemplary” is not necessarily to be construed as desirable or advantageous over other embodiments.

Embodiments of the present disclosure may be described in terms of functions or blocks that perform functions. Blocks which may be referred to as ‘units’ or ‘modules’ in the present disclosure may be physically implemented by analog or digital circuits such as logic gates, integrated circuits, microprocessors, microcontrollers, memories, passive electronic components, active electronic components, optical components, hardwired circuits, and the like, and may optionally be driven by firmware and software. Additionally, a term ‘unit’ means software or hardware elements such as field programmable gate array (FPGA) or application-particular integrated circuit (ASIC), and a “unit” performs some functions. However, a “unit” is not limited to hardware or software. A “unit” may be configured to be included in a storage medium that may be addressed, or configured to play one or more processors. Accordingly, as an example, a “unit” includes elements such as software elements, object-oriented software elements, class components, or task elements, processes, functions, attributes, procedures, subroutines, segments of a program code, drivers, firmware, micro-codes, circuits, data, database, data structures, tables, arrays, or variables. Functions provided in elements or “units” may be combined into a small number of elements or “units,” or separated into additional elements or “units.”

An embodiment of the present disclosure may be implemented using at least one software program running on at least one hardware device, and capable of performing network management functions to control elements.

Spatially relative terms such as “below,” “beneath,” “lower,” “above,” and “upper” may be used to easily describe a relationship of one component with other components as illustrated in the drawings. Spatially relative terms are to be understood as a term that includes other directions of the element in use or operation in addition to the direction illustrated in the drawings. For example, in a case in which a component shown in the drawing is described as being “below” or “beneath” another member, when the component is turned upside down, the component may be placed “above” the other member. Thus, the exemplary term “below” may include both downward and upward directions. Components may be oriented in other directions, and thus, the spatially relative terms may be interpreted according to the orientation.

Unless otherwise defined, all terms (including technical and scientific terms) used herein may be used as having a meaning that can be understood in common by one of ordinary skill in the art. In addition, terms defined in a generally used dictionary are not interpreted ideally or excessively, unless otherwise defined explicitly and particularly.

Hereinafter, embodiments of the present disclosure will be described in detail with reference to the attached drawings, in which like reference numerals designate like elements and repetitive explanation thereof will be omitted.

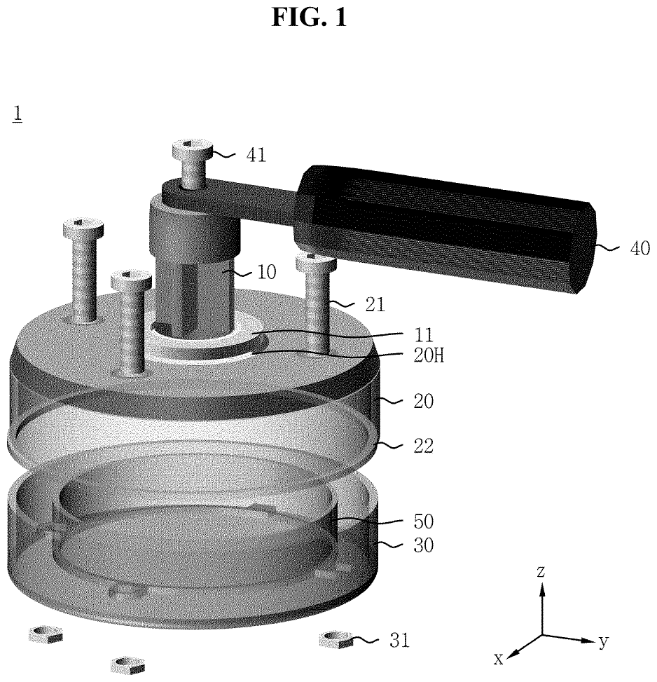

FIG. 1 is an exploded perspective view schematically illustrating a power generation device according to an exemplary embodiment of the present disclosure.

Referring to FIG. 1, a power generation device 1 may include a rotating shaft 10, a bearing 11, a first housing 20, a metal ring 22, a second housing 30, a handle 40, a power generation unit 50, bolts 21 and 41, and nuts 31.

The rotating shaft 10 may extend in a first direction (e.g., a z direction) and penetrate through inside of the first housing 20 and the second housing 30. The rotating shaft 10 may penetrate through a first hole 20H disposed in the first housing 20. The rotating shaft 10 may rotate according to external force.

The bearing 11 may be placed in the first hole 20H in the first housing 20 to surround the rotating shaft 10. The bearing 11 may be at least one of a ball bearing, a roller bearing, a plain bearing, a fluid bearing, a magnetic bearing, and a sleeve bearing. The bearing 11 may reduce static frictional force when the rotating shaft 10 rotates, and reduce vibrations inside and outside the power generation device 1.

The first housing 20 and the second housing 30 may constitute an outer appearance of the power generation device 1. The first housing 20 and the second housing 30 may be provided to accommodate components for operation of the power generation device 1. At least one of the first housing 20 and the second housing 30 may accommodate the power generation unit 50.

The first housing 20 and the second housing 30 may be arranged to face each other. The first housing 20 and the second housing 30 may be fixed to each other. For example, as shown in FIG. 1, holes into which the bolts 21 may be inserted may be disposed in the first housing 20. The bolts 21 having passed through the first housing 20 may penetrate through holes disposed through the second housing 30. The bolts 21 having penetrated through both the first housing 20 and the second housing 30 may be engaged with the nuts 31, and the first housing 20 and the second housing 30 may be fixed to each other through a screwing or hole-fixing method.

The metal ring 22 may be arranged at an edge of the first housing 20. Alternatively, the metal ring 22 may be placed within the first housing 20. The metal ring 22 may be configured to prevent electromagnetic interference (EMI) inside or outside the power generation device 1.

The handle 40 may be extended in a second direction (e.g., a y direction) perpendicular to the first direction (e.g., the z direction) and connected to the rotating shaft 10. The handle 40 may be fixed to the rotating shaft 10 by the bolts 41. An external force may be input to the handle 40, and the input external force may be transmitted to the rotating shaft 10 through the handle 40.

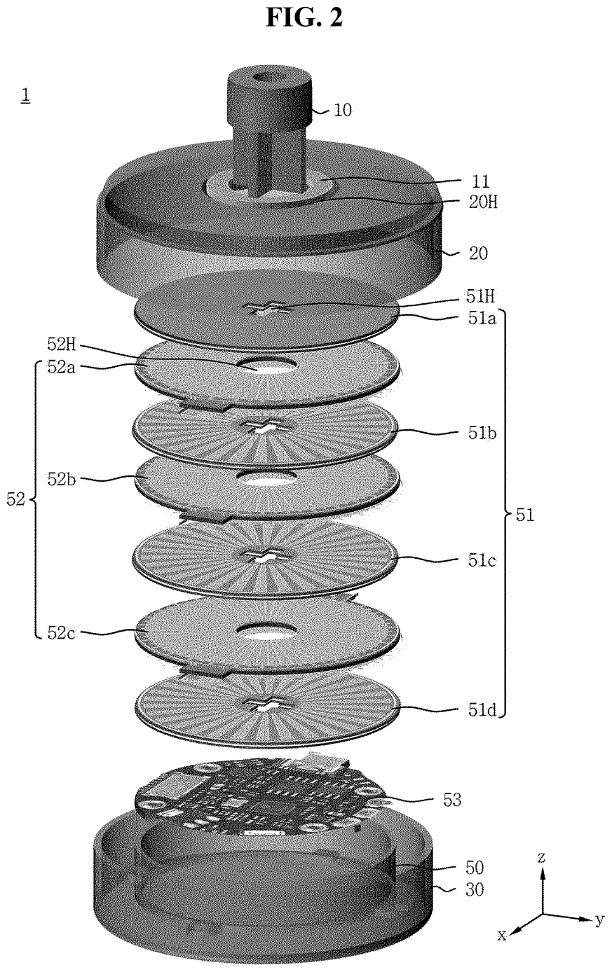

The power generation unit 50 may accommodate a rotating portion, a fixed portion, a wireless communication and alternating current (AC)-direct current (DC) conversion board, etc., which will be described later with reference to FIG. 2. The power generation unit 50 may be accommodated inside the second housing 30 as shown in FIG. 1.

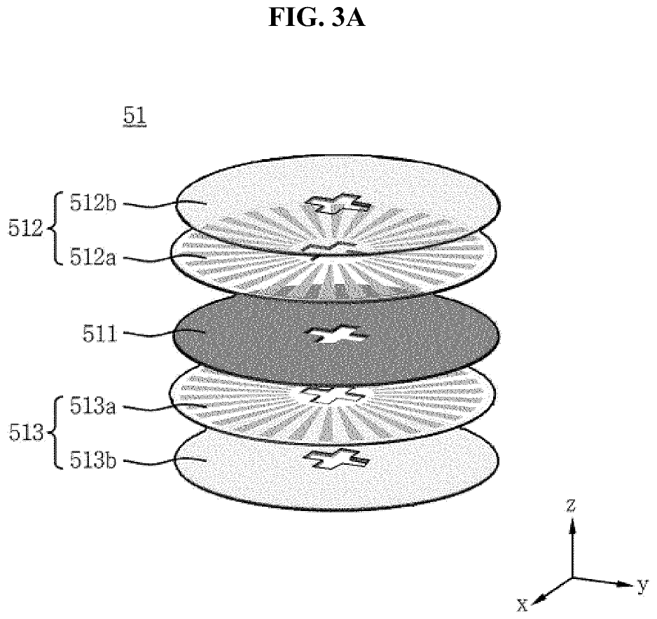

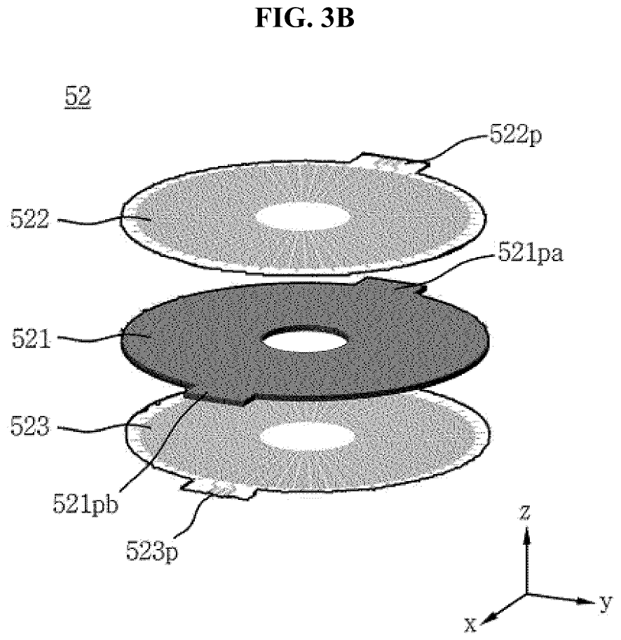

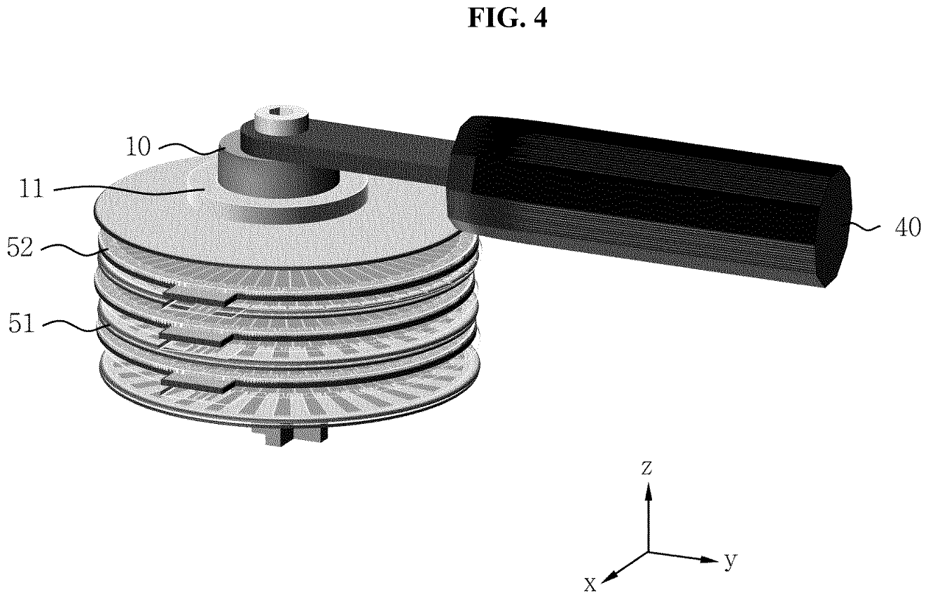

FIG. 2 is an exploded perspective view schematically illustrating an internal structure of the power generation device according to an exemplary embodiment of the present disclosure. FIG. 3 is an exploded perspective view schematically illustrating a rotating portion and a fixed portion according to an exemplary embodiment of the present disclosure. FIG. 4 is a perspective view schematically illustrating a structure in which the power generation device of FIG. 2 is partially assembled.

Referring to FIG. 2, the power generation device 1 may further include a rotating portion 51, a fixed portion 52, and a wireless communication and AC-DC conversion board 53.

The rotating portion 51 may include a second hole 51H having the rotating shaft 10 penetrating therethrough, and the fixed portion 52 may include a third hole 52H having the rotating shaft 10 penetrating therethrough. A size of the second hole 51H is substantially identical to a size of a penetration surface of the rotating shaft 10, and a size of the third hole 52H may be larger than the size of the second hole 51H. For example, as shown in FIG. 2, the penetration surface of the rotating shaft 10 and the second hole 51H may have a cross shape, and the third hole 52H may have a circular shape. The rotating portion 51 may rotate together when the rotating shaft 10 rotates through the second hole 51H.

In one embodiment, the rotating portion 51 may include a negative electrode friction material such as perfluoroalkoxy alkane (PFA) as a fluororesin-based material, flexible polyurethane foam (PFA, Polyurethane Foam Association), polyimide (PI), polytetra fluoroethylene (PTFE), polyethylene terephthalate (PET), polyacrylate, polyurethane, polyethylene, polyvinyl chloride phenol, polyvinyl alcohol, or the like. The fixed portion 52 may include a positive electrode material such as metal like gold, silver, nickel, or titanium, polyethylene oxide (PEO), aniline formaldehyde resin (AFR), nylon, ethylene chlorotrifluoroethylene (ECTFE), or a fluororesin-based material. However, the rotating portion 51 and the fixed portion 52 are not limited thereto.

In one embodiment, the rotating portion 51 and the fixed portion 52 may have a substantially disc shape.

In one embodiment, the rotating portion 51 and the fixed portions 52 may be respectively provided in plurality. The plurality of rotating portions 51 and the plurality of fixed portions 52 may be alternately arranged along the first direction (e.g., the z direction). For example, as illustrated in FIG. 2, the rotating portion 51 may include first to fourth rotating portions 51a, 51b, 51c, and 51d, and the fixed portion 52 may include first to third fixed portions 52a, 52b, and 52c. The first fixed portion 52a may be arranged between the first rotating portion 51a and the second rotating portion 51b. The second rotating portion 51b may be arranged between the first fixed portion 52a and the second fixed portion 52b. The second fixed portion 52b may be arranged between the second rotating portion 51b and the third rotating portion 51c. The third rotating portion 51c may be arranged between the second fixed portion 52b and the third fixed portion 52c. The third fixed portion 52c may be arranged between the third rotating portion 51c and the fourth rotating portion 51d.

Referring to FIG. 4, the plurality of rotating portions 51 and the plurality of fixed portions 52 may be alternately arranged and assembled to the rotating shaft 10.

Referring to FIG. 3A, the rotating portion 51 may include a first electrical insulation layer 511, a first negative charge inducing layer 512, and a second negative charge inducing layer 513. The first negative charge inducing layer 512, the first electrical insulation layer 511, and the second negative charge inducing layer 513 may be arranged along the first direction (e.g., the z direction). The first electrical insulation layer 511 may be arranged between the first negative charge inducing layer 512 and the second negative charge inducing layer 513. Meanwhile, one of the first negative charge inducing layer 512 and the second negative charge inducing layer 513 of the rotating portion 51 may not be included depending on arrangement of the rotating portion 51. For example, the first rotating portion 51a of FIG. 2 may not include the first negative charge inducing layer 512, and the fourth rotating portion 51d of FIG. 2 may not include the second negative charge inducing layer 513.

The first electrical insulation layer 511 may include flame retardant (FR) 4 (glass fiber reinforced epoxy resin).

The first negative charge inducing layer 512 may include a first electrode layer 512a and a first negative charge inducing material layer 512b. The first electrode layer 512a and the first negative charge inducing material layer 512b may be sequentially arranged on the first electrical insulation layer 511 along a +z direction. The first electrode layer 512a may be configured to have a fan rib shape with respect to the rotating shaft 10.

The second negative charge inducing layer 513 may include a second electrode layer 513a and a second negative charge inducing material layer 513b. The second electrode layer 513a and the second negative charge inducing material layer 513b may be sequentially arranged below the first electrical insulation layer 511 along a −z direction. The second electrode layer 513a may be configured to have a fan rib shape with respect to the rotating shaft 10. The first negative charge inducing layer 512 and the second negative charge inducing layer 513 may be symmetrical to each other with respect to the first electrical insulation layer 511.

The first electrode layer 512a and the second electrode layer 513a may include at least one metal material selected from gold (Au), silver (Ag), platinum (Pt), titanium (Ti), tin (Sn), copper (Cu), and zinc (Zn). The first negative charge inducing material layer 512b and the second negative charge inducing material layer 513b may include a fluororesin-based material. For example, the fluororesin-based material may include polytetrafluoroethylene (PTFE), Perfluoroalkoxy (PFA), fluorinated ethylene propylene (FEP), polychlorotrifluoroethylene (PCTF), ethylene tetrafluoroethylene (ETFE), ethylene-chlorotrifluoroethylene (ECTFE), polyvinylidene fluoride (PVDF), polyvinylfluoride (PVF), polyvinyl chloride (PVC), polyethylene (PE), or the like.

Referring to FIG. 3B, the fixed portion 52 may include a second electrical insulation layer 521, a first positive charge inducing layer 522, a first output portion 522p, a second positive charge inducing layer 523, and a second output portion 523p. The first positive charge inducing layer 522, the second electrical insulation layer 521, and the second positive charge inducing layer 523 may be arranged along the first direction (e.g., the z direction). The second electrical insulation layer 521 may be arranged between the first positive charge inducing layer 522 and the second positive charge inducing layer 523. The first positive charge inducing layer 522 and the first output portion 522p may be electrically connected to each other and arranged on a same layer. The second positive charge inducing layer 523 and the second output portion 523p may be electrically connected to each other and arranged on a same layer.

The second electrical insulation layer 521 may include a first protruding portion 521pa and a second protruding portion 521pb extending in the second direction (e.g., an x direction) crossing the first direction (e.g., the z direction) from a center portion having a disc shape. The first protruding portion 521pa and the second protruding portion 521pb may direct opposite to each other along the second direction (e.g., the x direction).

In one embodiment, the first protruding portion 521pa and the second protruding portion 521pb may be fixed into guide grooves disposed in the first housing 20, the second housing 30, or the power generation unit 50 each shown in FIG. 2. The fixed portion 52 may be fixed through the first protruding portion 521pa and the second protruding portion 521pb fixed into the first housing 20, the second housing 30, or the power generation unit 50, even during rotation of the rotating shaft 10.

The second electrical insulation layer 521 may include FR4 (glass fiber reinforced epoxy resin).

The first positive charge inducing layer 522 may be configured to have a fan rib shape with respect to the rotating shaft 10. An electrode density of the first positive charge inducing layer 522 may be higher than an electrode density of the first electrode layer 512a. The second positive charge inducing layer 523 may be symmetrical with the first positive charge inducing layer 522 with respect to the second electrical insulation layer 521.

The first output portion 522p may be placed on an upper surface (+z direction) of the first protruding portion 521pa, and the second output portion 523p may be placed on a lower surface (−z direction) of the second protruding portion 521pb.

The first positive charge inducing layer 522, the first output portion 522p, the second positive charge inducing layer 523, and the second output portion 523p may include at least one metal material selected from gold (Au), silver (Ag), platinum (Pt), titanium (Ti), tin (Sn), copper (Cu), and zinc (Zn).

The rotating portion 51 rotates according to rotation of the rotating shaft 10, and electric energy may be generated by triboelectrification between at least one of the first negative charge inducing layer 512 and the second negative charge inducing layer 513 and at least one of the first positive charge inducing layer 522 and the second positive charge inducing layer 523. The generated electric energy may be transmitted to the wireless communication and AC-DC conversion board 53 through the first output unit 522p and the second output unit 523p. The wireless communication and AC-DC conversion board 53 may use the transmitted electric energy to cope with requests for rescue and recovery in situations such as mountain rescue and natural disasters, etc.

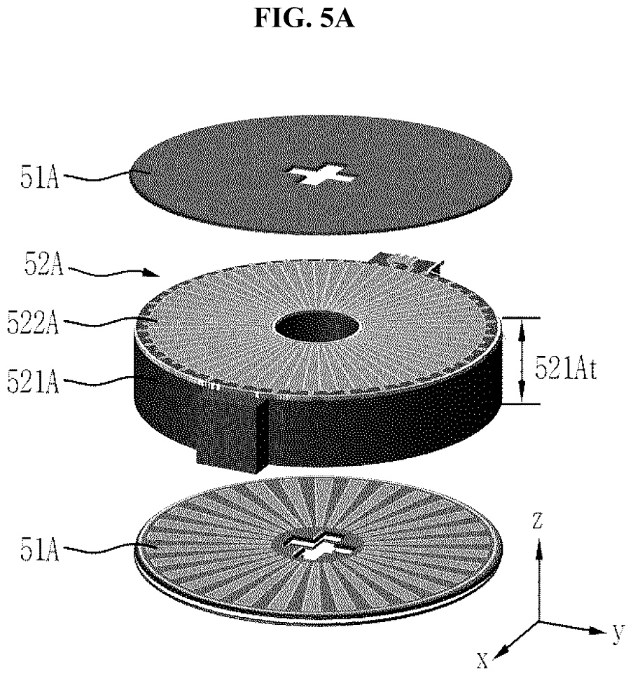

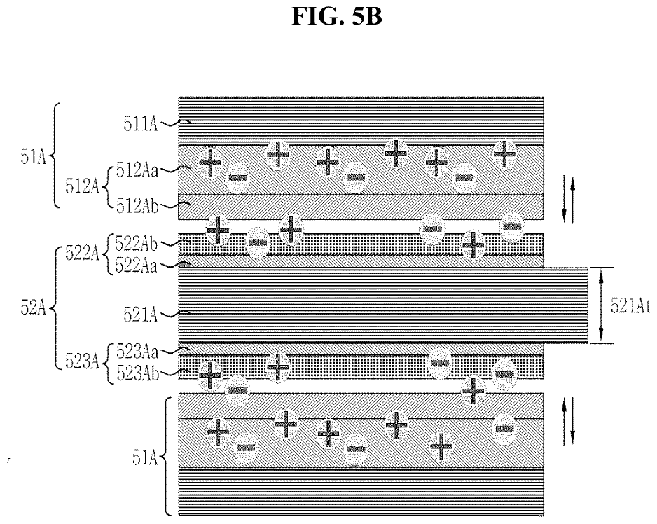

FIG. 5 is a schematic diagram of a rotating portion and a fixed portion according to an exemplary embodiment of the present disclosure. In detail, FIG. 5A shows a perspective view, and FIG. 5B shows a cross-sectional view.

Referring to FIG. 5A, a fixed portion 52A may be placed between rotating portions 51A. The fixed portion 52A may include a second electrical insulation layer 521A.

In one embodiment, a thickness 521At of the second electrical insulation layer 521A of the fixed portion 52A may be about 400 μm to about 1600 μm. In a method of power generation based on rotary friction, in a case in which a friction electric device or material is configured to have electrodes on both sides, when revolutions per minute (RPM) are increased and an amount of power generation is increased, a problem such that a potential is increased only on one side due to a particular potential difference may occur. That is, a phenomenon in which positive charges or negative charges move to a particular potential to move only in one direction toward one side among two sides of the device may occur, wherein the device having metal in a middle and a negative surface charge material such as PFA, PTFA, or the like on both sides. However, like one embodiment of the present disclosure, when the thickness 521At of the second electrical insulation layer 521A of the fixed portion 52A is about 400 μm to about 1600 μm, a physical phenomenon in which positive charges or negative charges move to a particular potential may be prevented. Accordingly, a power generation device having a greater amount of power generation may be implemented compared to when a friction electric device or material is configured to have electrodes on one side.

Referring to FIG. 5B, the rotating portion 51A may include a first electrical insulation layer 511A and a negative charge inducing layer 512A. The negative charge inducing layer 512A may include an electrode layer 512Aa and a negative charge inducing material layer 512Ab. The fixed portion 52A may include the second electrical insulation layer 521A, a first positive charge inducing layer 522A, and a second positive charge inducing layer 523A. Each of the first positive charge inducing layer 522A and the second positive charge inducing layer 523A may include electrode layers 522Aa, 522Ab, 523Aa, and 523Ab.

The first electrical insulation layer 511A and the second electrical insulation layer 521A may include FR4 (glass fiber reinforced epoxy resin).

The electrode layers 512Aa, 522Aa, 522Ab, 523Aa, and 523Ab may include at least one metal material selected from gold (Au), silver (Ag), platinum (Pt), titanium (Ti), tin (Sn), copper (Cu), and zinc (Zn). The negative charge inducing layer 512A may include a fluororesin-based material. For example, the fluororesin-based material may include polytetrafluoroethylene (PTFE), perfluoroalkoxy (PFA), fluorinated ethylene propylene (FEP), polychlorotrifluoroethylene (PCTF), ethylene tetrafluoroethylene (ETFE), ethylene-chlorotrifluoroethylene (ECTFE), polyvinylidene fluoride (PVDF), polyvinylfluoride (PVF), polyvinyl chloride (PVC), polyethylene (PE), or the like.

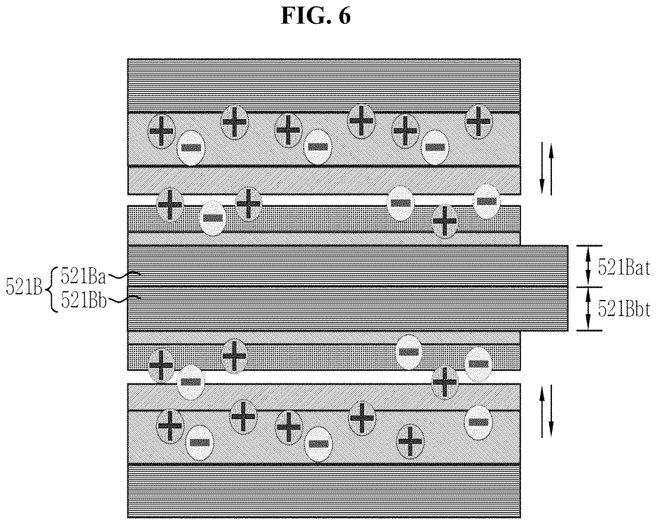

FIG. 6 is a cross-sectional view schematically illustrating a rotating portion and a fixed portion according to an exemplary embodiment of the present disclosure. In detail, FIG. 6 is a modified embodiment of FIG. 5. Hereinafter, a difference thereof from the embodiment described with reference to FIG. 5 is mainly described.

Referring to FIG. 6, the second electrical insulation layer 521B of the fixed portion may include a second-first electrical insulation layer 521Ba and a second-second electrical insulation layer 521Bb.

In one embodiment, the second-first electrical insulation layer 521Ba may have a thickness 521Bat of about 800 μm or less. For example, the second-first electrical insulation layer 521Ba may have a thickness 521Bat of about 200 μm to about 800 μm.

In one embodiment, the second-second electrical insulation layer 521Bb may have a thickness 521Bbt of about 800 μm or less. For example, the second-second electrical insulation layer 521Bb may have a thickness 521Bbt of about 200 μm to about 800 μm.

In one embodiment, a total thickness of the second electrical insulation layer 521B may be about 1600 μm or less.

For example, a total thickness of the second electrical insulation layer 521B may be about 400 μm to about 1600 μm.

In this case, even when the second-first electrical insulation layer 521Ba and the second-second electrical insulation layer 521Bb include a same material, arrangement in the second-first electrical insulation layer 521Ba may be different from arrangement in the second-second electrical insulation layer 521Bb due to manufacture characteristics. Since the second-first electrical insulation layer 521Ba and the second-second electrical insulation layer 521Bb have different arrangements, even when a total thickness of the second electrical insulation layer 521B is smaller than the thickness 521At of the second electrical insulation layer 521A of FIG. 5 described above, a physical phenomenon in which positive charges or negative charges move to a particular potential may be prevented. That is, a power generation device having a greater amount of power generation may be implemented compared to when a friction electric device or material is configured to have electrodes on one side using a thin electric insulation layer.

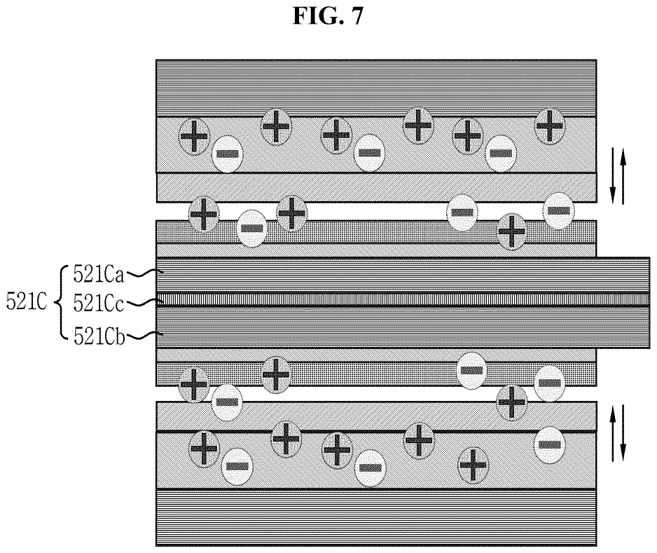

FIG. 7 is a cross-sectional view schematically illustrating a rotating portion and a fixed portion according to an exemplary embodiment of the present disclosure. In detail, FIG. 7 is a modified embodiment of FIG. 5. Hereinafter, a difference thereof from the embodiment described with reference to FIG. 5 is mainly described.

Referring to FIG. 7, a second electrical insulation layer 521C of the fixed portion may include a second-first electrical insulation layer 521Ca, a second-second electrical insulation layer 521Cb, and a second-third electrical insulation layer 521Cc disposed between the second-first electrical insulation layer 521Ca and the second-second electrical insulation layer 521Cb.

In one embodiment, the second-third electrical insulation layer 521Cc may be an electrical insulation layer different from the second-first electrical insulation layer 521Ca and the second-second electrical insulation layer 521Cb. For example, the second-third electrical insulation layer 521Cc may include a polymer-based insulator.

In this case, as described above with reference to FIG. 5, a physical phenomenon in which positive or negative charges move to a particular potential on an opposite side may be prevented, and a power generation device that ensures a great amount of power generation may be implemented. In detail, by adding a different electrical insulation layer in a middle, insulating properties are increased. Thus, even when a total thickness of the second electrical insulation layer 521C is smaller than the thickness 521At of the second electrical insulation layer 521A of FIG. 5 described above, a phenomenon in which electrons move to an opposite side may be prevented. For example, a total thickness of the second electrical insulation layer 521C may be about 600 μm.

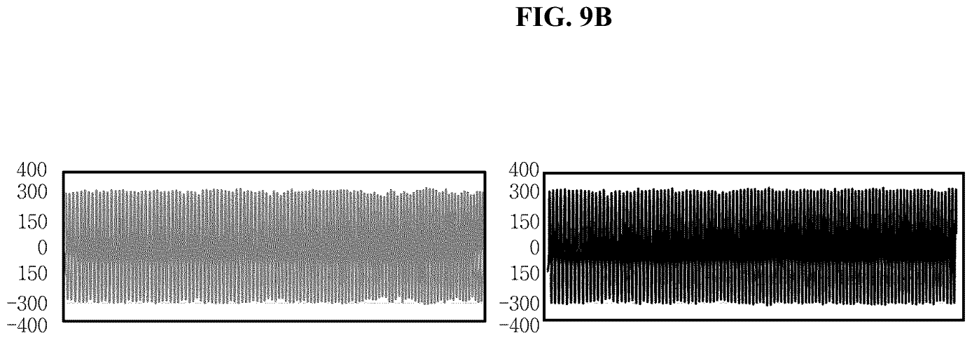

When an electrical insulation layer of the fixed portion has a thickness of 250 μm or less, a phenomenon in which charges move only to a particular side with a high impedance resistance even at 600 rpm or higher in a power generation device configured for double-sided power generation and having a circular diameter of 50 mm during rotary power generation has occurred. On the other hand, when a different insulating material (or an electrical and thermal protection material) having a thickness of 100 μm is added between electrical insulation layers with a thickness of approximately 250 μm to constitute an electrical insulation layer with a total thickness of 600 μm, it is checked that even when a circular diameter exceeds 600 mm, a phenomenon in which charges move to a particular side to thereby reduce an amount of power generation does not occur, but a large amount of power is generated. A detailed description will be provided later with reference to FIG. 9.

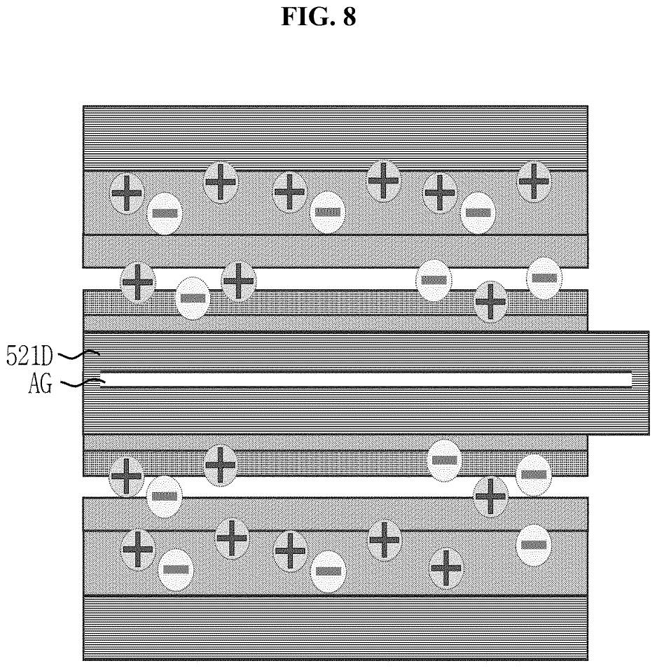

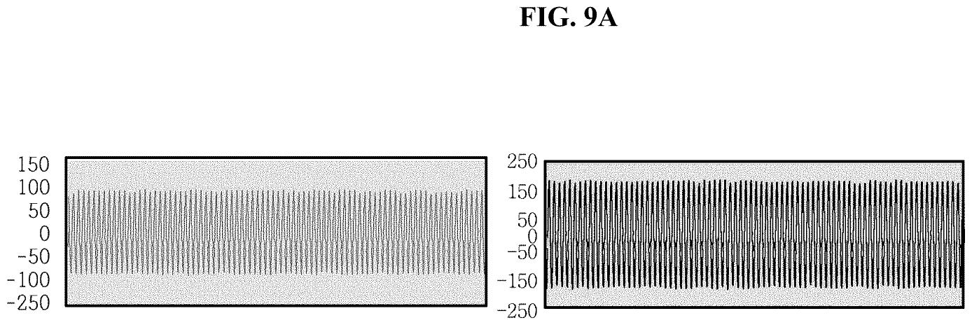

FIG. 8 is a cross-sectional view schematically illustrating a rotating portion and a fixed portion according to an exemplary embodiment of the present disclosure. In detail, FIG. 8 is a modified embodiment of FIG. 5. Hereinafter, a difference thereof from the embodiment described with reference to FIG. 5 is mainly described.

Referring to FIG. 8, a second electrical insulation layer 521D of the fixed portion may have at least one air gap AG therein. In this case, as described above with reference to FIG. 5, a physical phenomenon in which positive and negative charges move to a particular potential may be prevented due to the air gap AG, and a power generation device that ensures a great amount of power generation may be implemented. In detail, even when a total thickness of the second electrical insulation layer 521D is smaller than the thickness 521At of the second electrical insulation layer 521A of FIG. 5 described above, a phenomenon in which electrons move to an opposite side may be prevented due to the air gap AG.

FIG. 9 illustrates graphs showing a power generation amount in a comparative example and a power generation amount according to the embodiment of FIG. 7.

Referring to FIG. 9A, an amount of power generation in the comparative example is shown. A comparative example shows a case when an electrical insulation layer of a fixed portion has a thickness of 250 μm or less, and in a case of rotary power generation, a phenomenon in which charges in a power generation device configured for double-sided power generation move only to a particular side having a high impedance resistance. Therefore, it may be checked that an amount of power generation is small due to a potential difference on one side of the power generation device for double-sided power generation (see a blue graph on a left side), and it may be understood that an amount of power generation on another side is also decreased (see a red graph on a right side).

Referring to FIG. 9B, an amount of power generation according to the embodiment of FIG. 7 is shown. That is, when a different insulating material having a thickness of 100 μm is added between electrical insulation layers having a thickness of approximately 250 μm to constitute an electrical insulation layer with a total thickness of 600 μm, even when a circular diameter exceeds 600 mm, it may be checked that a phenomenon in which charges move to a particular side to thereby reduce an amount of power generation does not occur, but an amount of power generation is great both on one side (see a blue graph on a left side) and on another side (see a red graph on a right side).

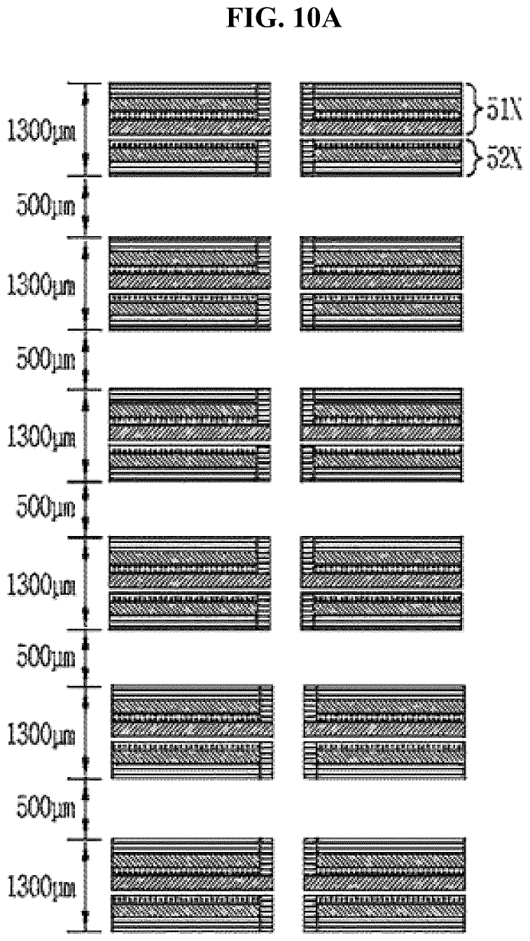

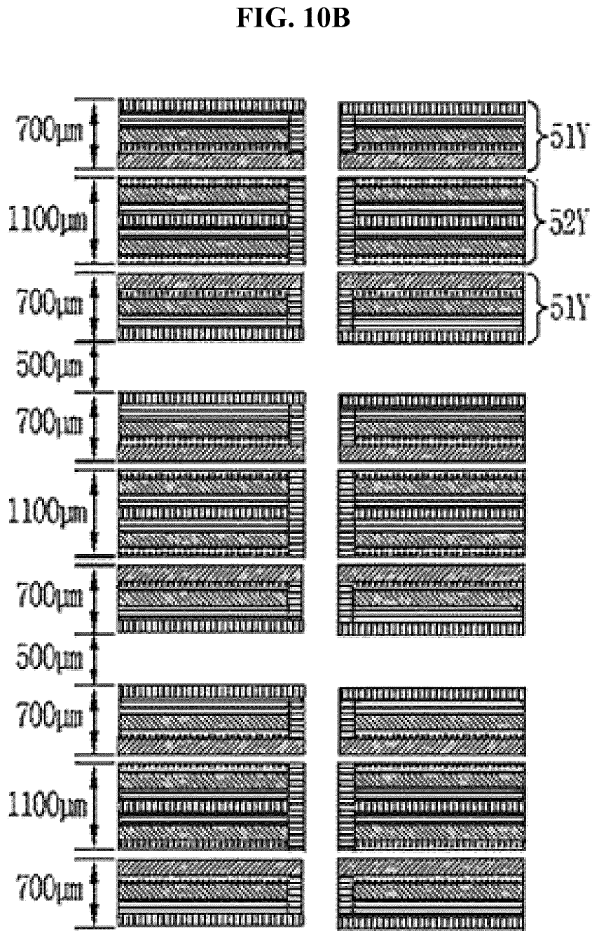

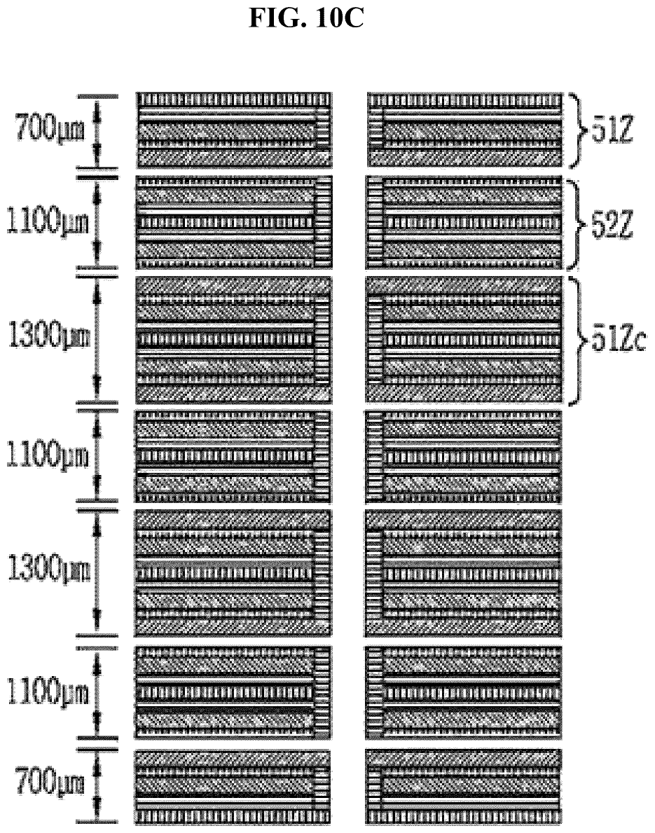

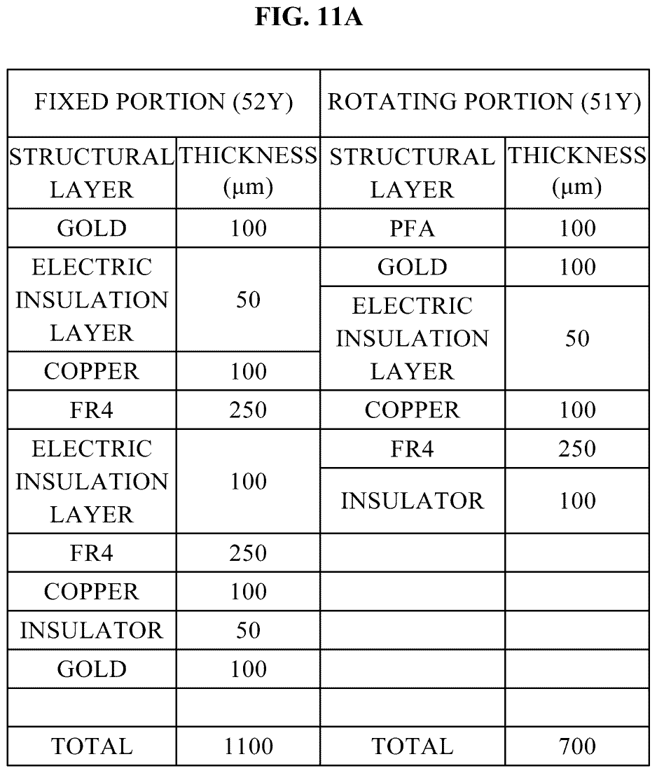

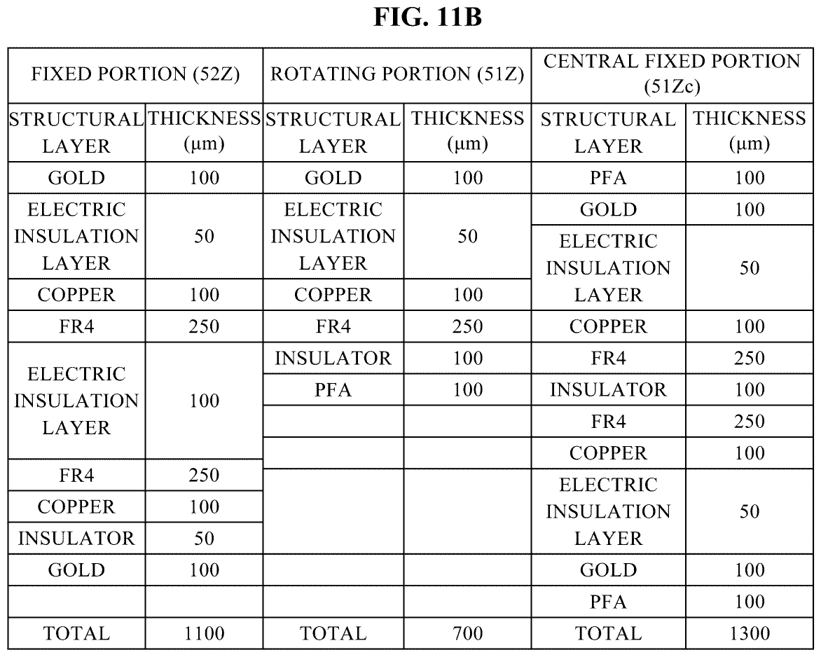

FIG. 10 illustrate cross-sectional views showing a difference between total heights of elements according to single-sided power generation and double-sided power generation in a rotating portion and a fixed portion. FIG. 11 show tables specifically presenting thicknesses (heights) of the rotating portion and the fixed portion of FIG. 10B and FIG. 10C.

Referring to FIG. 10, when a fixed or rotating portion configured for double-sided power generation is provided in a structure of a multi-stage synchronization element to increase current, a whole height according to elements may be reduced.

Referring to FIG. 10A, a single element is used regardless of a thickness, but in a case of a power generation device based on rotary friction using a multi-element synchronization technique, when a phenomenon in which a synchronization axis of power generation in an AC waveform between elements is unsynchronized in one waveform such that a power generation form in one element is accelerated or delayed in the units of ms occurs, this may result in energy loss due to reverse current or resistance in other synchronized elements. Thus, not only a power generation amount in the element but also an output from synchronized elements may be reduced, resulting in a negative effect such that nearly double a power reduction occurs in unsynchronized elements. Accordingly, even when a single element is used, a thickness (height) of each of a fixed portion 52X and a rotating portion 51X needs to be at least 400 μm. When a height of each of the rotating portion 51X or the fixed portion 52X is 200 μm or less, various problems such that a central portion uplifting phenomenon or a phenomenon in which edges of a plate material of the rotating portion are bent downward due to high-speed rotation of or vertical force on the rotating portion, or deformation of a waveform or mass imbalance due to friction on a circular shape of the fixed portion may occur. Generally, in a power generation device based on rotary friction configured for single-sided power generation, a minimum thickness of 900 to 1, 100 μm is needed when the fixed portion 52X, the rotating portion 51X, and a portion of melt bonding/spraying/electrical/dip coating of a polymer-based negative charge for induction between two electrodes are included. Further, in consideration of a rotational friction speed of 100 rpm or more at a diameter of 50 mm, the fixed portion 52X and the rotating portion 51X each need a thickness of 500 to 600 μm to solve the above-described problem. In addition, in consideration of negative charge coating (100 μm), one power generation configuration in a whole power generation device based on rotary friction needs to have a total height of 1100 to 1300 μm in a single generator layer. When the single power generation layer (including the fixed portion 52X and the rotating portion 51X) is defined as having a height of 1300 μm, a six-element layer configuration needs to include air-cooled spaces between power generation elements to minimize an effect of interlayered power generation energy and perform air-cooled discharge on friction-generated heat according to rotation, and an air-cooled space needs at least 500 μm. Thus, ‘six’ single generator layers and ‘five’ air-cooled spaces may be disposed, which accounts for a total thickness (height) of 10, 300 μm. This may be expressed in Equation below.

When one height of a single generator layer sGL including the fixed portion 52X, the rotating portion 51x, and an inductive coating material is defined as sGL^{h}, and a number of the single generator layers is defined as n, a height of n layers may be defined as sGL^{h}×n. At this time, since an air-cooled space AC has n−1 layers, a height (h) of a power generation device having single-sided electrodes may be calculated as presented below.

A height of a power generation device having single-sided electrodes (STENG^{h})=sGL^{h}×n+AC^{h}×(n−1)

Referring to FIG. 10B and FIG. 11A, when an electrical insulation layer is disposed between two sides using an electrical and thermal protection material, even when a 200 μm thickness of an insulation material including FR4 is reduced to ½ according to both sides in the fixed portion 52Y or the rotating portion 51Y, power generation is not affected. In addition, when the fixed portion 52Y is configured for double-sided power generation, the fixed portion 52Y may further include an intermediate electrical insulation layer (100 μm), and a gold-based composite material and a copper layer (100 μm) on opposite sides. Accordingly, one fixed portion 52Y configured as a double-sided generator layer has a size of 1000 to 1100 μm, and the rotating portion 51Y is configured as a single-sided generator layer, and two rotating portions 51Y disposed at a top and a bottom, respectively, constitute one power generation device. That is, one air-cooled space is reduced, and a height may be reduced from 3100 μm (see FIG. 10A) to 2500 μm by about 20%. An insulator included in the rotating portion 51Y includes a material with high flexibility, heat resistance, and chemical resistance, such as polyoxymethylene (PFA), polyimide, Teflon, or silicon, and may be configured as a film or coating. The insulator described above may provide insulation between elements and safety when charges are induced during power generation based on a double-sided power generation device, thereby minimizing an influence on induced electromotive force and protecting a device that generates power at a high voltage from strong external impact.

In a case in which only one double-sided power generator layer is defined in the fixed portion 52Y and the rotating portion 51Y includes a single-sided generator layer, when six layers are present in a power generation device, a height of about 8,500 μm is needed. When a height of a double generator layer (dGL) including the fixed portion 52Y, the rotating portion 51Y, and the inductor is defined as dGL^{h}, this height is 1.92 times greater than sGL^{h}. Since the height is sGL^{h}×1.92, one double generator layer is disposed with respect to two double-sided rotating generators, and may be defined as dGL^{h}=sGL^{h}×1.92×n/2. With respect to double-sided power generation, the air-cooled space AC disposed between a rotating portion 51Y and a rotating portion 51Y has a space of 500 μm, and since two even-numbered double-sided rotating generators have one air-cooled space, the air-cooled space is calculated by

$$\frac{n}{2} - 1.$$

Thus, a height h of the whole double-sided generation device based on rotation may be calculated as follows.

An entire height of a double-sided rotary power generation device (STENG^{h})=sGL^{h}×1.92×n/2+Ac^{h}×(n/2−1)

Referring to FIG. 10C and FIG. 11B, when two rotating portions 51Zc are configured for double-sided generation, since the two rotating portions 51Zc in six layers are configured for double-sided generation, a height of the rotating portions 51Zc configured for double-sided generation is 1,300 μm, and a total thickness (height) of a whole power generation device based on rotary friction including a total of six layers is 7,300 μm, resulting in a reduction by up to 30% compared to 10,300 μm of a single layer. However, in this case, since there is a limit in coping with heat generation caused by friction, only low RPM may be used. Considering use of high RPM, an air gap for reducing a height by 18% may be disposed. However, this only applies to a power generation device including six layers. When ten or more layers are disposed, efficiency increases by up to 25% when rotary power generation is performed using a fixed portion configured for double-sided generation rather than when rotary power generation is performed using a fixed portion and a rotating portion both configured for single-sided generation.

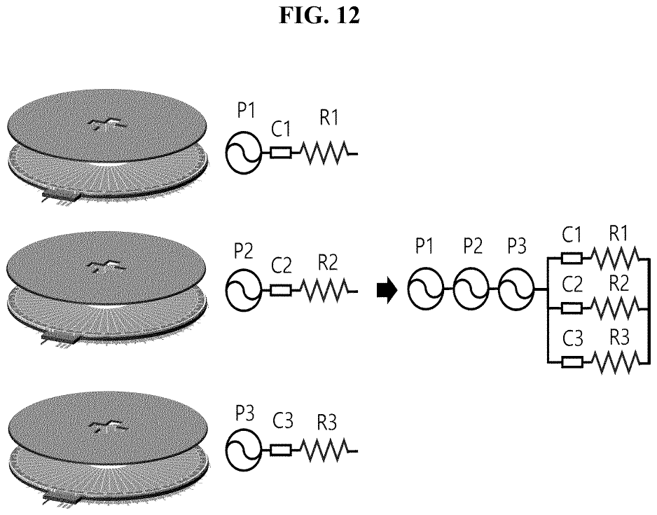

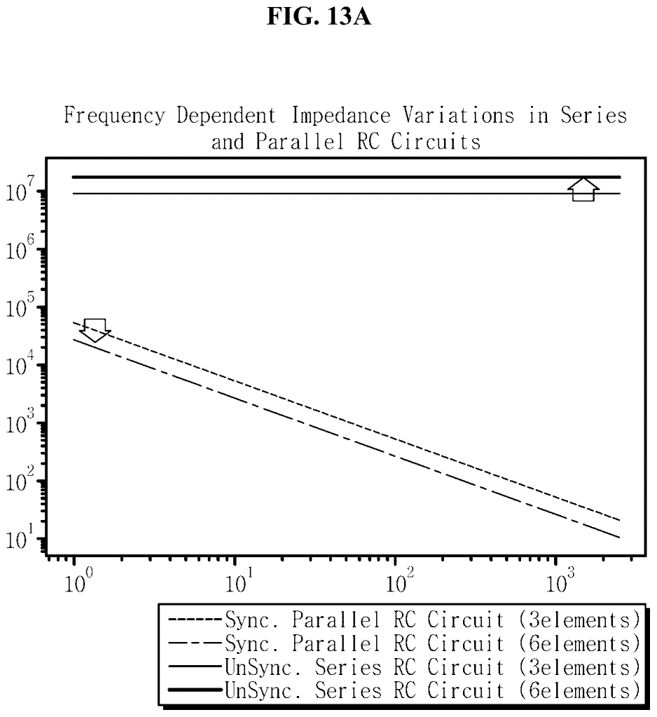

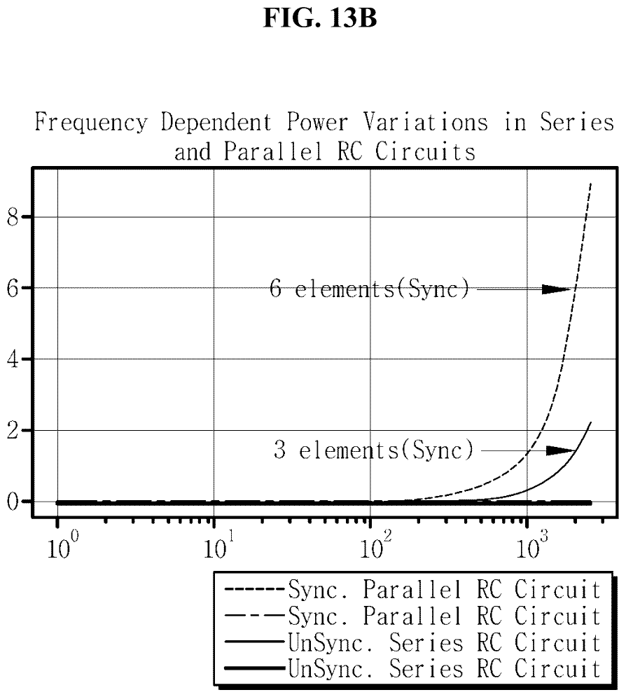

FIG. 12 is an exemplary diagram for explaining synchronization of a power generation device according to an exemplary embodiment of the present disclosure. FIG. 13 is a graph showing a comparison of an impedance (Z) and power of a device according to synchronization and unsynchronization of a power generation device.

Referring to FIG. 12, a three-layered power generation device is illustrated, but this may be also applied to a six-layered power generation device. Therefore, assuming that a six-layered power generation device is used, an impedance of the power generation device may be expressed based on a synchronized RC circuit as presented below.

$${Z}_{paralle \_ sync} = 1 / [ ( 1 / {R}_{1} + 1 / {R}_{2} + 1 / {R}_{3} + 1 / {R}_{4} + 1 / {R}_{5} + 1 / {R}_{6} ) + jw ( {C}_{1} + {C}_{2} + {C}_{3} + {C}_{4} + {C}_{5} + {C}_{6} ) ]$$

An unsynchronous RC circuit is described as presented below.

$${Z}_{series \_ unsync} = {R}_{1} + {R}_{2} + {R}_{3} + {R}_{4} + {R}_{5} + {R}_{6} + 1 / [ jw ( \frac{1}{{C}_{1}} + \frac{1}{{C}_{2}} + \frac{1}{{C}_{3}} + \frac{1}{{C}_{4}} + \frac{1}{{C}_{5}} + \frac{1}{{C}_{6}} ) ]$$

Referring to FIG. 13A, it may be understood that compared to the three-layered power generation device, an impedance of the six-layered power generation device is decreased during synchronization, but an impedance thereof increases in unsynchronous operation. Revolutions per minute according to rotational force is associated with a number of occurrences of friction. When friction occurs for 100 times per minute, generated energy is remarkably increased. When synchronized layers are increased, an impedance is decrease. Thus, generated energy increases proportionally to the revolutions per minute. That is, an impedance may be lowered by parallelization of a power generation device and synchronization of power generation. For example, as a result of measurement, it may be checked that an impedance is reduced from 3 MΩ to 1 MΩ by ⅓ compared to a single-element device, and in a case of a six-element double-sided power generation device, an impedance is reduced to 300 kΩ.

Also, referring to FIG. 13B, it may be checked that, with respect to power, there is no increase in current during unsynchronization even when elements are increased from three elements to six elements.

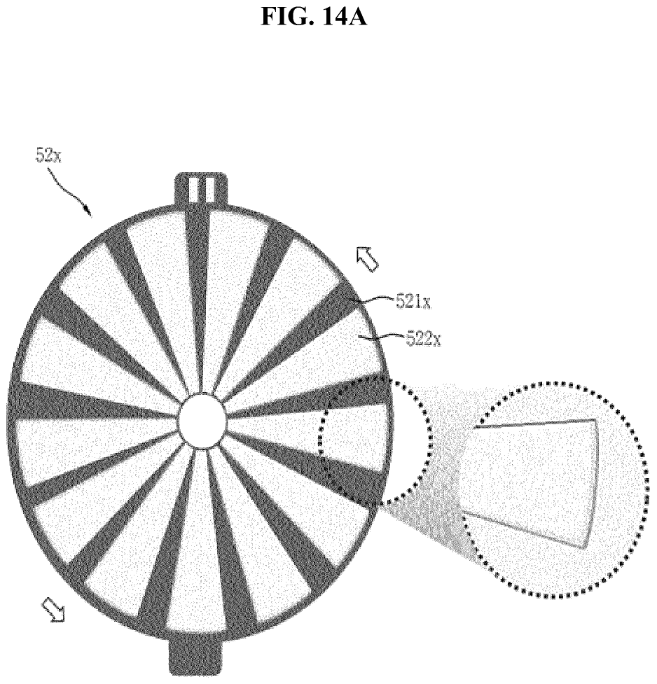

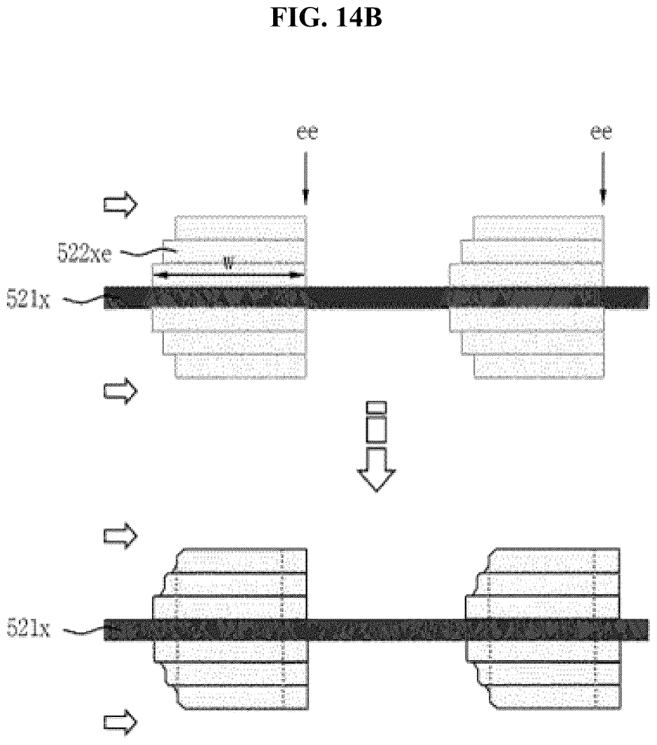

FIG. 14 is a diagram for explaining a fixing portion according to an exemplary embodiment of the present disclosure. In detail, FIG. 14 illustrates a plan view of the fixed portion in FIG. 14A, and a cross-sectional view of the fixed portion in FIG. 14B when the fixed portion rotates in a particular direction (e.g., counterclockwise).

Referring to FIG. 14A and FIG. 14B, a fixed portion 52x may include an electrical insulation layer 521x and positive charge inducing layers 522x. The positive charge inducing layers 522x may be symmetrical to each other with respect to the electrical insulation layer 521x. Each of the positive charge inducing layers 522x may include electrode layers 522xe. The electrode layers 522xe may have different widths w and be arranged in parallel with each other along one direction.

In one embodiment, the widths w of the electrode layers 522xe may be gradually decreased in a direction away from the electrical insulation layer 521x of the fixed portion 52x.

In one embodiment, the electrode layers 522xe may have one side edge ee respectively, and the respective one side edges ee overlap one another in one direction.

The electrode layers 522xe may have a size and a shape of a circle with fan ribs. The electrode layers 522xe are made of various metal materials according to each element based on gold plating, and may have a height ranging from 0.5 to 100 μm. A height of the electrode layers 522xe is associated with an amount of power generation of a power generation device. In the related art, research into rotary friction on a single element shows that when an electrode has a great height, a potential difference is increased, thus resulting in great power generation. However, as mentioned above, since a non-insulation layer in a single element is configured to have a height of 16 mm to 20 mm to implement smoothness, research has been conducted into electrodes configured to have a height of 1 to 5 mm. However, when a height of electrodes is increased, electrodes on a rotating plate and a fixed plate are worn out quickly due to rolling friction during friction rotation. Thus, maintaining wear characteristics and machinability become difficult, and fine metal powder and fine particles caused by wearing out are induced to a rotating plate by static electricity due to the rotation, which directly affects reduction in power generation having long-term drivability.

Like one embodiment of the present disclosure, when the electrode layers 522xe are configured to have a form of steps in consideration of machinability, wear characteristics may be minimized. The electrode layers 522xe are obtained by a chemical oxidation-reduction reaction and may include a synthetic material including gold-based metal (nickel, tin, silver, etc.). In most deposition processes, deposition is performed in units of 0.3 μm to several tens of μm for each element, and a total height of an electrode having multiple layers is less than 100 μm. However, this structure is used in a power generation device based on rotary friction and having a diameter of several tens of centimeters or less. When a diameter thereof is 50 cm to 100 cm, a height of the electrode layers 522xe is increased to 100 μm or greater. At this time, to promote a processibility, an etched structure having three steps with a total height of 3/h by performing etching, rather than deposition, and when a height of the power generation device exceeds a meter, a height of the electrode layers 522xe is also increased in units of mm. Accordingly, when a height of the electrode layers 522xe is 3 mm or more, the electrode layers 522xe are etched into a step shape in units of mm. As a circular diameter of the power generation device based on rotary friction increases, a number of the electrode layers 522xe may be increased or an area of the electrode layers 522xe is increased. When a diameter of the power generation device is increased, centrifugal force is increased and a phenomenon in which electrons jumping between electrodes occurs, and thus, power is not generated. Therefore, the number of electrodes is not further increased from a certain diameter, and an area of the electrode layers 522xe is increased. As an area and a circular diameter of an electrode are increased, a voltage is increased, thereby increasing high charge mobility due to rotary friction. Thus, electric force which causes a phenomenon in which a fixed portion is in closed contact with a rotating portion is increased. In this case, a problem caused by the electric force may be minimized by raising electrodes in the fixed and rotating portions to remove causes of resistance to a rotation speed and stopping power generation.

At this time, a height of an inclined plane of a step structure of the electrode layers 522xe is configured to have an angle of 50 and 70 degrees in consideration of wear characteristics. Electrodes of the rotating plate are deposited or etched according to sizes of the rotating plate and the electrodes along an axis corresponding to a direction of rotation. Thus, not only wear characteristics may be reduced compared to when a height of the electrode layers 522xe is disposed vertically, but also operations in a production process may be also simplified and costs are reduced compared to when machining is performed to obtain a trapezoid. Accordingly, durability and reliability of the power generation device based on rotary friction may be secured.

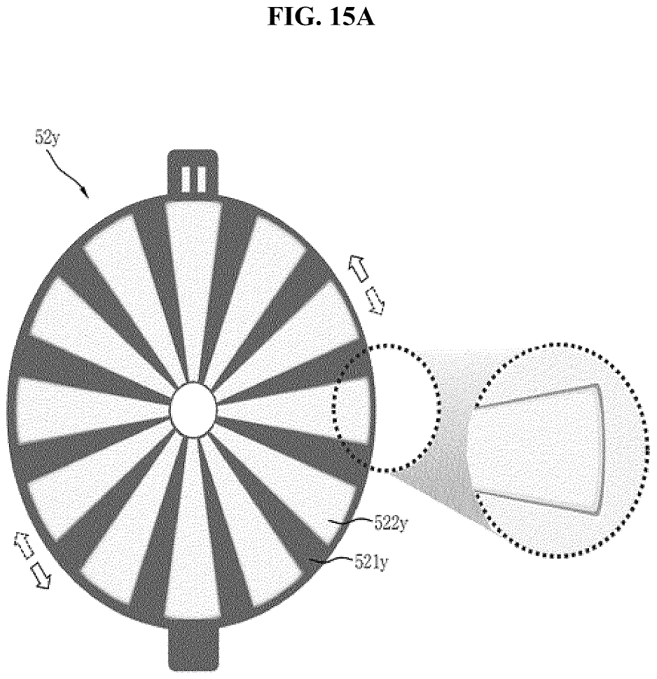

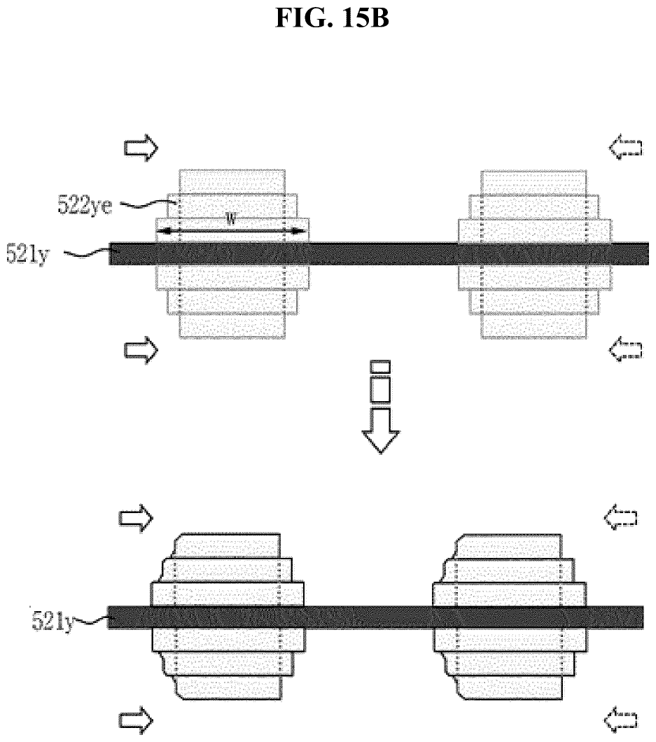

FIG. 15 is a diagram for explaining a fixing portion according to an exemplary embodiment of the present disclosure. In detail, a plan view of the fixed portion is shown in FIG. 15A, and a cross-sectional view of the fixed portion is shown in FIG. 15B, regardless of a rotational direction of the fixed portion.

Referring to FIG. 15A and FIG. 15B, the fixed portion 52y may include an electrical insulation layer 521y and positive charge inducing layers 522y. The positive charge inducing layers 522y may be symmetrical to each other with respect to the electrical insulation layer 521y. Each of the positive charge inducing layers 522y may include electrode layers 522ye. The electrode layers 522ye may have different widths w and be arranged in parallel with each other along one direction.

In one embodiment, widths w of the electrode layers 522ye may be gradually decreased in a direction away from the electrical insulation layer 521y of the fixed portion 52y.

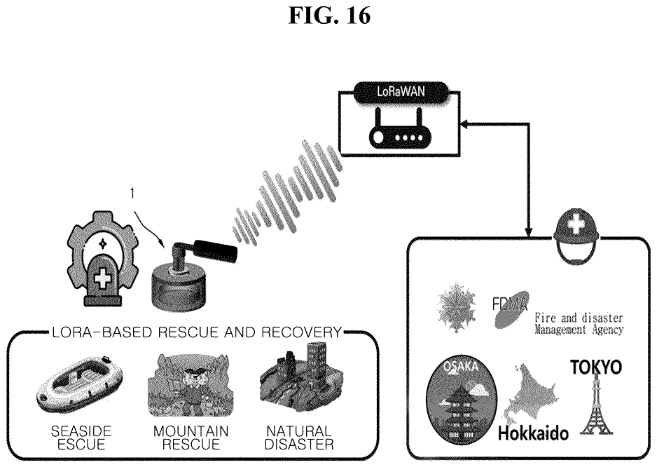

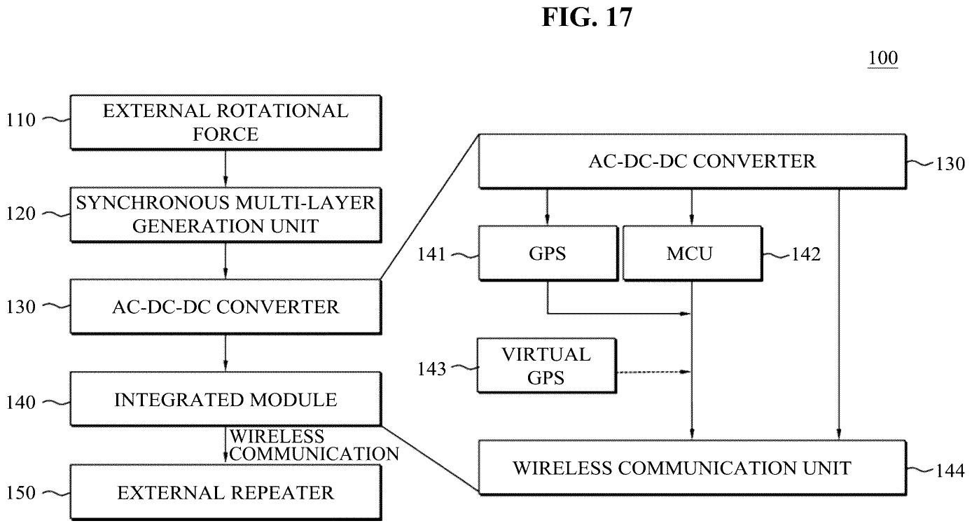

FIGS. 16 and 17 are diagrams for explaining an example of utilizing the power generation device according to an exemplary embodiment of the present disclosure.

Referring to FIG. 16, self-generation or centrifugal power generation may be utilized in various fields such as Internet of things (IoT) and medical fields. For example, a double-sided self-generating device 1 may be used as a self-generating system for rescue and recovery purposes. General rescue and recovery systems request rescue through batteries. However, due to characteristics of an environment of a rescue and recovery system, a rescue and recovery system is used once every few months or years in disasters and calamities, and many battery-based systems are difficult to use due to discharging of batteries in an environment in which the battery-based systems are not used. In particular, in regions where power is not supplied or in disaster situations where it is difficult to supply power, remote rescue using a self-generation system is needed, and the remote rescue may be also used in various situations such as earthquakes, tsunamis, and heavy snow in nearby Japan.

Referring to FIG. 17, a self-generating rescue system 100 may include a synchronous multi-layer generation unit 120 based on rotary friction in association with a mechanism including a bearing connected to a rotating shaft, an AC-DC-DC converter 130, and an integrated module 140. A display device may be mounted on the mechanism in the integrated module 140, or included in the integrated module 140. The integrated module 140 may include a global positioning system (GPS) 141, a microcontroller unit (MCU) 142, a virtual GPS 143, and a wireless communication unit 144.

Hereinafter, a flowchart of operation the self-generating rescue system 100 is described. When a rescuer or a user who needs to transmit a location applies an ‘external rotational force 110’, the ‘synchronous multi-layer generation unit 120 based on rotary friction’ generates power by the external rotational force 110 and supplies the power to the AC-DC-DC converter 130. The ‘AC-DC-DC converter 130’ supplies power capable of operating for 100 ms or more to the ‘MCU 142’, the ‘wireless communication unit 144,’ and the ‘GPS 141’ via an AC or DC circuit connected to the power generation device. The GPS 141 collects location information for 100 ms and transmits the location information to the MCU 142. Then, the MCU 142 notifies an external repeater 150 of the location information via wireless communication (BLE, Lora, WiFi, etc.) based on GPS information. However, here, the GPS 141 is configured to provide location information, and when GPS 141 is not present, information of the virtual GPS 143 may be acquired by the MCU 142 and then transmitted to the wireless communication unit 144.

Although the power generation device has been mainly described in the present disclosure, but the present disclosure is not limited thereto. For example, it may be understood that a method for manufacturing the power generation device may fall within the scope of the present disclosure.

Although the present disclosure has been described with reference to an embodiment illustrated in the drawings, this is only an example, and it will be understood by those of ordinary skill in the art that various changes in the form and details may be made therein without departing from the spirit and scope of the present disclosure.

This research patent was supported by the Ministry of SMEs and Startups and the Korea Startup Promotion Agency through the DIPS 1000+ program (20241755) as part of the Super Gap Startup Development Project.

This research patent was supported by the 2022 research fund from the Ministry of Science and ICT and the National Research Foundation of Korea (NRF) under the Electronic Medicine Technology Development Program (2022M3E5E9016662).

This research patent was supported by the 2023 research fund from the Ministry of Trade, Industry and Energy and the Korea Evaluation Institute of Industrial Technology (KEIT) under the Next-Generation Intelligent Semiconductor Technology Development Program (20025736).

What is claimed is:

1. A power generation device comprising:
a first housing having a first hole through which a rotating shaft penetrates, the rotating shaft being configured to be rotated by external force and extending in a first direction;
a rotating portion having a second hole through which the rotating shaft penetrates to be thereby rotated by the rotating shaft, and comprising a first negative charge inducing layer and a second negative charge inducing layer each arranged along the first direction, and a first electric insulation layer between the first negative charge inducing layer and the second negative charge inducing layer; and
a fixed portion having a third hole through which the rotating shaft penetrates, and comprising a first positive charge inducing layer and a second positive charge inducing layer each arranged along the first direction, and a second electric insulation layer between the first positive charge inducing layer and the second positive charge inducing layer,
wherein, according to rotation of the rotating shaft and the rotating portion, electric energy is generated by triboelectrification between at least one of the first negative charge inducing layer and the second negative charge inducing layer and at least one of the first positive charge inducing layer and the second positive charge inducing layer, and
the second electric insulation layer of the fixed portion has at least one air gap therein.

2. The power generation device of claim 1, wherein the rotating portion and the fixed portion are provided in plurality, respectively, and
the plurality of rotating portions and the plurality of fixed portions are alternately arranged along the first direction.

3. The power generation device of claim 1, wherein the second electric insulation layer of the fixed portion has a thickness of about 400 μm to about 1600 μm.

4. The power generation device of claim 1, wherein the second electric insulation layer of the fixed portion comprises a second-first electric insulation layer and a second-second electric insulation layer sequentially arranged along the first direction, and
the second-first electric insulation layer and the second-second insulation layer have different internal material arrangements from each other.

5. The power generation device of claim 1, wherein the second electric insulation layer of the fixed portion comprises a second-first electric insulation layer, a second-second electric insulation layer, and a second-third electric insulation layer disposed between the second-first electric insulation layer and the second-second electric insulation layer, and
the second-third electric insulation layer comprises an insulating material different from an insulation material of each of the second-first electric insulation layer and the second-second electric insulation layer.

6. The power generation device of claim 1, wherein each of the first positive charge inducing layer and the second positive charge inducing layer of the fixed portion comprises a plurality of electrode layers having widths different from each other and arranged in parallel along the first direction.

7. The power generation device of claim 6, wherein the widths of the plurality of electrode layers gradually decrease in a direction away from the second electric insulation layer of the fixed portion.

8. The power generation device of claim 6, wherein the plurality of electrode layers have one side edge respectively, the respective side edges overlapping one another in the first direction.

9. The power generation device of claim 1, wherein the first negative charge inducing layer and the second negative charge inducing layer of the rotating portion are symmetrical to each other with respect to the first electric insulation layer of the rotating portion, and
the first positive charge inducing layer and the second positive charge inducing layer of the fixed portion are symmetrical to each other with respect to the second electric insulation layer of the fixed portion.

10. The power generation device of claim 1, wherein the second hole has a size substantially identical to a size of a penetration surface of the rotating shaft, and
the third hole has a size larger than the size of the second hole.

11. The power generation device of claim 1, wherein each of the rotating portion and the fixed portion has a disc shape, and
the second electric insulation layer of the fixed portion comprises a protruding portion extending from the disc shape in a second direction crossing the first direction.

12. The power generation device of claim 11, wherein the protruding portion comprises a first protruding portion and a second protruding portion directing opposite to each other along the second direction, and
the fixing portion further comprises:
a first output portion disposed on an upper surface of the first protruding portion and electrically connected to the first positive charge inducing layer; and
a second output portion disposed on a lower surface of the second protruding portion and electrically connected to the second positive charge inducing layer.

13. The power generation device of claim 1, further comprising a bearing disposed within the first hole and surrounding the rotating shaft.

14. The power generation device of claim 1, further comprising a handle which extends in a second direction perpendicular to the first direction to be connected to the rotating shaft, and to which the external force is input.

15. The power generation device of claim 1, further comprising a second housing arranged to face the first housing and fixed to the first housing,
wherein the rotating portion and the fixed portion are arranged within the second housing.
